(19) United States
(12) Patent Application Publication
(10) Pub. No.: US 2014/0032334 A1
(43) Pub. Date: Jan. 30, 2014

(54) PRICE AND INVENTORY PREDICTION FOR DISPLAY CONTENT

(71) Applicant: GOOGLE INC., Mountain View, CA (US)

(72) Inventors: Aitan Y. Weinberg, Brooklyn, NY (US); Oren Eli Zamir, Los Altos, CA (US); Qing Xu, San Jose, CA (US); Anusha Sriraman, Sunnyvale, CA (US); Eu-Jin Goh, Palo Alto, CA (US); Alok Aggarwal, Foster City, CA (US)

(73) Assignee: Google Inc., Mountain View, CA (US)

(21) Appl. No.: 13/853,755

(22) Filed: Mar. 29, 2013

(30) Foreign Application Priority Data
Jul. 26, 2012 (IL) 221155

(51) Int. Cl. G06Q 30/02

(52) U.S. Cl. CPC G06Q 30/0275
USPC 705/14.71

(57) ABSTRACT

A computer-implemented method includes receiving a computer-implemented model to process parameters of a content delivery campaign and a bid price for delivery of content in content delivery slots. The price to be paid is based on a losing bid. Processing the parameters and bid price determines an estimated price to be paid for the delivery of content and a metric describing an estimated result of the content delivery campaign. The method also includes receiving parameters of the content delivery campaign and the price to be bid for delivery of content. The method also includes processing the model and the price to be bid to determine the estimated price to be paid and the metric describing the estimated result of the content delivery campaign. The method also includes providing information about the estimated price and the estimated result to a content provider to facilitate selection of a final bid price.

### CROSS-REFERENCE TO RELATED APPLICATION

This application claims foreign priority to Israeli Patent Application No. 221155, entitled, “METHOD AND COMPUTER PROGRAM PRODUCT FOR DETERMINING ESTIMATED PRICE TO BE PAID FOR THE DELIVERY OF ON-LINE CONTENT,” filed Jul. 26, 2012, the entirety of which is hereby incorporated by reference.

### BACKGROUND

The present disclosure relates generally to estimating results of a campaign for online content delivery, such as an advertisement campaign. The present disclosure more specifically relates to generating estimates of the cost and metrics of success of a content delivery campaign.

Content providers, such as advertisers, generally seek to get the best value possible from a content delivery campaign. A content provider will pay for a content delivery campaign on the basis of one of a few industry-standard metrics. Two particularly significant such metrics are CPM (cost per impression, also often expressed as the cost for one thousand impressions) and CPC (cost per click). The idea of what constitutes “value” in a content delivery campaign can be measured differently for different content providers. For example, some brand advertisers are looking simply for impressions, which raise public awareness of the brand. Other content providers might be more immediately concerned with achieving a certain number of clicks and/or conversions.

### SUMMARY

Implementations of methods for facilitating selection of a bid price for a content delivery campaign are described herein. These implementations may relate to content-delivery campaigns based on information relating to a user identifier. In some implementations, a user can control a plurality of properties associated with their attribute data or the attribute data associated with an anonymous user device or user identifier (e.g., a cookie). For example, the user may view and/or edit their attribute data. A user may select to opt in or opt out of having their attribute data collected and/or transmitted. A user may also control these properties for some or all web sites. For example, the user may specify that a certain web site cannot store any attribute information associated with the user. In another example, the user may restrict an entity from determining or storing certain types of attribute information. In some implementations, content activity attribute may be completely anonymous (e.g., an entity cannot associate attribute data with a unique user identifier).

One implementation is a method including receiving, by a computer system, a computer-implemented model adapted to process parameters of a content delivery campaign and a price to be bid for delivery of content in available content delivery slots as part of the content delivery campaign. The price to be paid for delivery of content in the available content delivery slots is based on at least one losing bid. The processing of the parameters and price to be bid determines an estimated price to be paid for the delivery of content and a metric describing an estimated result of the content delivery campaign. The method also includes receiving, by the computer system, parameters of the content delivery campaign and the price to be bid for delivery of content in available content delivery slots as part of the content delivery campaign. The method also includes processing, by the computer system, the model and the price to be bid, to determine the estimated price to be paid for the delivery of content and the metric describing the estimated result of the content delivery campaign. The method also includes providing information about the estimated price and the estimated result to a content provider to facilitate selection of a final bid price for the content delivery campaign.

Another implementation is a computer-readable storage medium encoded with instructions that, when executed on a processing unit, perform a method. The method includes receiving, by a computer system, a computer-implemented model adapted to process parameters of a content delivery campaign and a price to be bid for delivery of content in available content delivery slots as part of the content delivery campaign. The price to be paid for delivery of content in the available content delivery slots is based on at least one losing bid. The processing of the parameters and price to be bid determines an estimated price to be paid for the delivery of content and a metric describing an estimated result of the content delivery campaign. The method also includes receiving, by the computer system, parameters of the content delivery campaign and the price to be bid for delivery of content in available content delivery slots as part of the content delivery campaign. The method also includes processing, by the computer system, the model and the price to be bid, to determine the estimated price to be paid for the delivery of content and the metric describing the estimated result of the content delivery campaign. The method also includes providing information about the estimated price and the estimated result to a content provider to facilitate selection of a final bid price for the content delivery campaign.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is a diagram of a web page in accordance with a described implementation;

FIG. 3 is a flow diagram of a process in accordance with described implementations.

FIG. 4 is a diagram of a user interface in accordance with described implementations.

### DETAILED DESCRIPTION

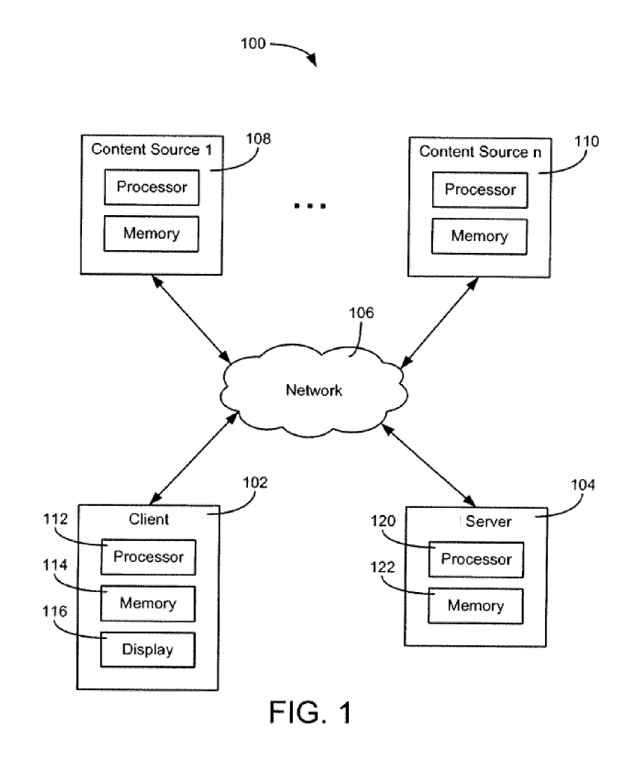

Referring to FIG. 1, a block diagram of a computer system 100 in accordance with a described implementation is shown. System 100 includes a client 102 which communicates with other computing devices via a network 106 and which is associated with at least one user identifier. For example, client 102 may communicate with one or more content sources ranging from a first content source 108 up to an nth content source 110. Content sources 108, 110 may provide webpages and/or media content (e.g., audio, video, and other forms of digital content) to client 102. System 100 may also include a server 104, which may perform analytics on the webpages provided by content sources 1-n and also may provide content to be included in the webpages over network 106. The content to be included in the webpages may include advertisements that are configured to be displayed to a user identifier of client 102 in a web browser that is displaying one or more of the webpages.

Network 106 may be any form of computer network that relays information between client 102, server 104, and content sources 108, 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different user electronic devices configured to communicate via network 106 (e.g., a laptop computer, a desktop computer, a tablet computer, a smartphone, a digital video recorder, a set-top box for a television, a video game console, etc.). Client 102 is shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client 102 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which visually displays webpages using webpage data received from content sources 108, 110 and/or from server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Media content may include, but is not limited to, webpage data, a movie, a sound file, pictures, and other forms of data, including advertisement data, such as may be displayable as part of a webpage. Similarly, server 104 may include a processing circuit including a processor 120 and a memory 122. In some implementations, server 104 may include several computing devices (e.g., a data center, a network of servers, etc.). In such a case, the various devices of server 104 may be in electronic communication, thereby also forming a processing circuit (e.g., processor 120 includes the collective processors of the devices and memory 122 includes the collective memories of the devices).

Server 104 may provide content to client 102 via network 106. For example, content source 108 may provide a webpage to client 102, in response to receiving a request for a webpage from client 102. In some implementations, content from server 104 may be provided to client 102 indirectly. For example, content source 108 may receive content from server 104 and use the content as part of the webpage data provided to client 102. In other implementations, content from server 104 may be provided to client 102 directly. The content also may include one or more advertisements selected for delivery as described in detail below. For example, content source 108 may provide webpage data to client 102 that includes a command to retrieve content from server 104. On receipt of the webpage data, client 102 may retrieve content from server 104 based on the command and display the content when the webpage is rendered on display 116. The content also may include one or more advertisements selected for delivery as described in detail below.

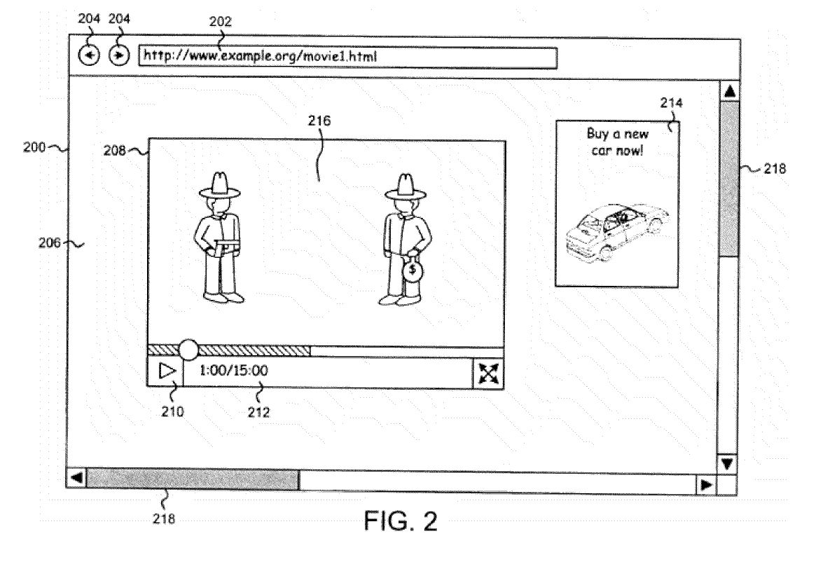

As shown in FIG. 2, the one or more processors in communication with display 200 may execute a web browser application (e.g., display 200 is part of a client device). The web browser application operates by receiving input of a uniform resource locator (URL) into a field 202, such as a web address, from an input device (e.g., a pointing device, a keyboard, a touchscreen, or another form of input device). In response, one or more processors executing the web browser may request data from a content source corresponding to the URL via a network (e.g., the Internet, an intranet, or the like). The content source may then provide webpage data and/or other data to the client device, which causes visual indicia to be displayed by display 200.

In general, webpage data may include text, hyperlinks, layout information, and other data that is used to provide the framework for the visual layout of displayed webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “movie1.html” provided by the website, “www.example.org.” The webpage data may include data that specifies where indicia appear on webpage 206, such as movie 216 or other visual objects. In some implementations, the webpage data may also include additional URL information used by the client device to retrieve additional indicia displayed on webpage 206. For example, the file, “movie1.html,” may also include one or more tags used to retrieve a display advertisement 214 from a remote location (e.g., the server 104, the content source that provides webpage 206, etc.) and to display the display advertisement 214 on display 200.

When a user identifier is engaged in online activity, e.g., while using a web browser to access content on the internet, as shown on display 200, the user identifier may be presented with content including advertisements, such as display advertisement 214, that may have been selected from among different available advertisements from remote sources on the basis of an auction process. An operator of a webpage, such as webpage 206, may accept bids from content providers for the opportunity to serve content, such as display advertisement 214, on the webpage. In other cases, a content delivery agent may act as an intermediary between one or more webpages and one or more content providers to arrange for the provision of content from the content providers to the webpages.

The bids for the opportunity to provide content may include a set of criteria defining the kinds of situations in which the content provider is most interested in serving content. For example, a content provider that provides advertisements relating to women's athletic apparel may be interested primarily in the opportunity to serve such advertisements when the webpage and the advertisement will be provided to a user identifier associated with certain demographic traits, such as female gender, specific age groups more strongly associated with participation in athletic activity, and the like. In some cases, such as when a content delivery agent acts as an intermediary, the content provider also may be able to express preferences for which webpages should be most likely to receive and display the advertisement. For example, the content provider serving advertisements for women's athletic apparel may prefer that the advertisements are served with a webpage concerned primarily with discussion of women's professional basketball and that the impressions of the advertisements are not used on a webpage of a dating service for senior citizens.

The bids for the opportunity to provide content also include price information. The price information may be expressed in a variety of ways. One example is CPM, or cost per impression. The CPM thus expresses the maximum amount that the content provider is willing to pay for each occasion on which the content is served on the webpage. As the total amount of traffic to webpages may be large, and thus the total number of possible impressions also large, CPM may conventionally be expressed as a cost per one thousand impressions, rather than a cost for a single impression.

Another example of price information that may be submitted as part of a bid is CPC, or cost per click. The CPC thus expresses the maximum amount that the content provider is willing to pay for each occasion on which the content that is served on the webpage receives a click from a viewer of the webpage, e.g., following a link contained in the served content. In some implementations, a content provider that makes a bid expressing price information as a CPC may in fact pay the cost of the content delivery campaign not on the basis of clicks actually received, but on the basis of a predicted click-through rate for the content that is served, based on the context in which it is served.

When a webpage is requested by a client, the webpage may have an available slot for third party content to be server along with the webpage. The selection of what content is chosen to be provided with the webpage may be based on the bids previously submitted by content providers. Based on the available information about the current instance of the webpage that is to be served, a content delivery agent, such as may be present at server 104, can identify bids from content providers that match the present circumstances. Bids may indicate various types of circumstances delineating when the bid should be accessed. For example, the content provider may only want the content to be served with an instance of a webpage of particular categories and industries. For example, an athletic goods company may only want its advertisements to be served with webpages that have a connection with athletics, and may not want to pay for impressions on unrelated webpages. The content provider also may only want the content to be served to a client associated with specific types of demographic data. For example, the content provider may only want to provide the content to particular age groups. The content provider also may only want the content to be served during specific times or on specific dates. For example, an advertisement promoting the opening day of a baseball season would only be relevant prior to opening day.

A content provider also may have submitted multiple bids to provide content. For example, the content provider may be running an advertising campaign in which a number of different advertisements are in active rotation. Each different advertisement that is part of the advertising campaign may be represented by a separate bid to the content delivery agent. In other implementations, a content provider may submit a single bid for the content delivery campaign, and in cases where the bid is accepted, one or more items of content can be selected for delivery. In some cases, the content to be delivered pursuant to the winning bid may be selected randomly. In other cases, the content to be delivered may be part of a queue or ordered list, and each successive time content is to be served for the content delivery campaign, the next item of content in the list would be selected and delivered. In still other implementations, the decision of which content to deliver may be more complicated. For example, a function could be provided to consider the circumstances in which the content is to be delivered, such as time and place of delivery, details about the webpage, etc. and to select the content most likely to be effective.

As another example, a content provider may enter multiple bids for several, or even for a single item of content to be served, but with a bid price that depends on the circumstances. For example, for a brand advertisement for a luxury men's clothing line, the advertiser may be willing to pay more for impressions on webpages associated with men's interest magazines, but only willing to pay less for impressions on webpages associated with professional sports leagues. Similarly, the advertiser may be willing to pay more for impressions that occur shortly before an upcoming sale than at other times when potential customers are expected to be less inclined to shop.

When the content delivery agent has a slot to fill with content, the bids that are active based on the circumstances as just described are then compared based on bid price, with the highest bid winning The price paid by the content provider for delivering the content is generally not the bid price, however. Instead, the price paid is the highest price that was bid by a losing bidder, i.e., the second-place bid. The bid price thus sets a maximum price to be paid for delivering the content, but does not actually allow the content provider to know ahead of time the exact price that will be paid.

The content provider also does not know ahead of time how successful the content delivery campaign will be. One element of uncertainty is the fact that in any situation where content is being delivered, estimates can be made about how those viewing the content will react based on past results, but actual results cannot be known ahead of time with precision. For example, an advertiser may know that a brand impression delivered in a certain location on a popular webpage frequented by certain key demographics has resulted in a consistent rate click-through rate in the past. That rate may be used as an estimate for future click-through rates in similar circumstances.

Similarly, a content-provider may have, based on historical data, an estimated rate of conversion associated with providing content in known circumstances. When a visitor to a website navigates to a goal webpage or completes some other predefined interaction or task, such as clicking on an interactive display advertisement this may be referred to as a “conversion.” Content-providers may also have estimates for the average amount of revenue that they expect to receive in connection with a conversion. The relative success of a content-delivery campaign may thus be expressed as a function of this estimate. The campaign has attendant expenses, namely the price paid for delivering the content, and revenues, namely the revenues associated with conversions. The total price paid for delivering content can be expressed as the total number of impressions, multiplied by the average cost per impression. Alternatively, the total price paid for delivering content may be expressed as the total number of click-throughs received or estimated to be received, multiplied by the average cost per click. Similarly, the total revenue can be expressed as the total number of conversions, multiplied by the average revenue received in association with a conversion. The total number of conversions, however, is expected to depend on the number of impressions or click-throughs, with more of the latter resulting in more of the former, and fewer of the latter resulting in fewer of the former. The total price paid for delivering content likewise is dependent on the average price paid per impression or click-through, which is expected to be related to, but not equal to the CPC or CPM. This is because CPM and CPC express the maximum prices, but the actual prices depend on what other content providers bid for the same content-delivery slot.

This uncertainty poses a difficulty for content providers in planning a content delivery campaign, because it is difficult to estimate the total cost of running a campaign for a particular duration, and it is difficult to estimate the total value of the campaign in terms of revenues gained compared to expenses paid. In the past, content providers have generally needed to make educated guesses, with varying degrees of success and confidence. Content providers have thus had to set bid prices without precision, based mostly on intuition.

The primary variable that content providers can control to adjust the cost of a content-delivery campaign and/or to adjust the total volume of content delivered is the unit price the content provider bids at auction, i.e. the CPM or CPC, which in turn affects the unit price the content provider pays on average. Generally, when the unit price paid by the content provider increases, both the total cost and total volume of content delivered as part of the content delivery campaign (e.g., number of impressions, click-throughs) are expected to increase as well. An increase in volume of content delivered is generally a good thing for the content provider, as it tends to correspond to an increase in conversions, and thus it also tends to correspond to an increase in revenue for the content provider. An increase in cost, however, is not desirable for the content provider, and thus choosing a price point for a content delivery campaign involves balancing competing factors in a trade-off.

Content providers can make informed decisions regarding their desired price points if they can know the expected distributions of volume of content delivered and total costs of content delivery beforehand. Determining such expected distributions is not always straightforward, however, due to the bidding process that is used to determine which available slots for providing content are awarded to the advertiser and at what price. A reason why this can be difficult to determine is because the content provider can only set the content provider's bid price, but the actual price paid when a bid is successful is the second-highest price that was bid for the content slot in question. One aspect of a system described herein automatically predicts a distribution of the actual prices that will be paid and the total volume of impressions that will be won by content providers, given a particular bid price.

As an example, a content provider may achieve ‘x’ number of conversions, generate revenue of ‘y’ for each conversion, and realize an overall cost per conversion of ‘CPA’. To maximize revenue, the content provider would thus like to maximize the expression ‘x*(y−CPA)’. The content provider can adjust the CPC (or CPM) in an attempt to improve this value. For example, the content provider may try lowering its CPC, which may thereby also lower the CPA so that (y−CPA) is maximized. However, this also can cause the number of conversions to drop. Conversely, the content provider may try raising its CPC, thereby also raising the number of conversions, ‘x’. However, this also may cause the CPA to rise, thus reducing the term (y−CPA). By using the price and inventory prediction system, the content provider can see clearly how many conversions and what CPA they can get if they set CPC to a particular value, thus making it much easier for the content provider to find a preferred CPC using the prediction system.

The prediction system employs a statistical learning algorithm that takes campaign settings of content providers (such as what remarketing user lists, age and gender they are interested in) and time as inputs and uses these features to predict the distribution of price and impressions, clicks and conversions. An exemplary algorithm uses logistic regression or a support vector machine combined with feature selection based on information entropy, and runs on historical data to first learn the model and then make predictions for the future upon request by a content provider. The learning algorithm is provided training data, in which data from exemplary historical content delivery campaigns is provided. By analyzing the results of the past content delivery campaigns, the learning algorithm can be trained to predict results of future content delivery campaigns given the operating parameters of the content delivery campaign, including the bid price.

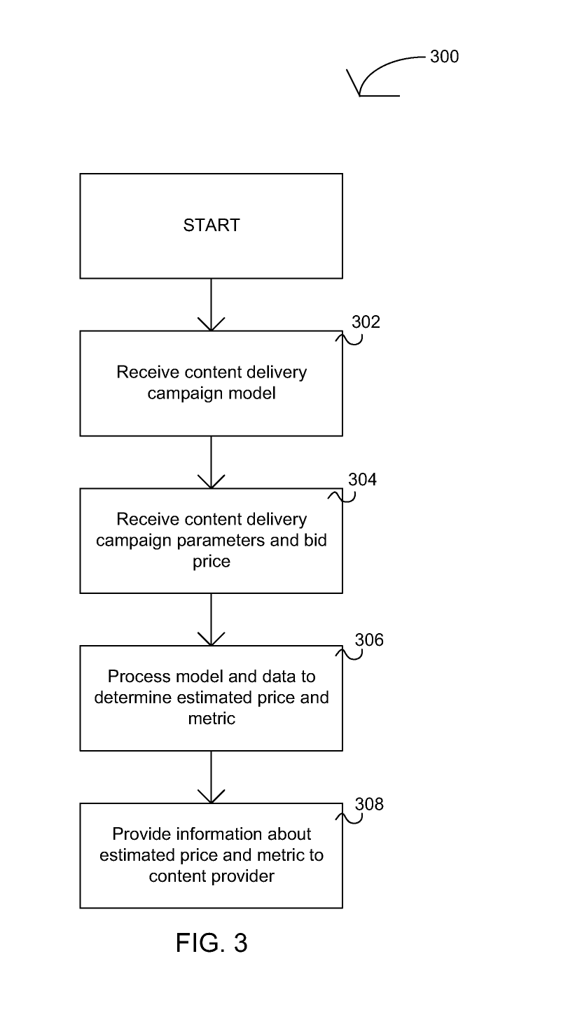

A process 300 in accordance with described implementations is now described with reference to FIG. 3. The process begins at block 302, where a model of a content delivery campaign is received. The model is configured to accept as inputs parameters of the content delivery campaign and a bid price for the content delivery campaign, and to process the parameters of the content delivery campaign and the bid price for the content delivery campaign to produce as output an estimated price to be realized as part of the content delivery campaign and at least one metric describing an estimated result of the content delivery campaign. The estimated result may include at least one of a number of impressions realized during the content delivery campaign, a number of clicks received by impressions delivered during the content delivery campaign, and a number of conversions realized during the content delivery campaign.

The process continues at block 304, where content delivery campaign parameters and the bid price are received. The process continues at block 306, where the model and the data, including content delivery campaign parameters and the bid price, are processed to determine the estimated price and the metric. The process continues at block 308, where information about the estimated price and metric are provided to the content provider.

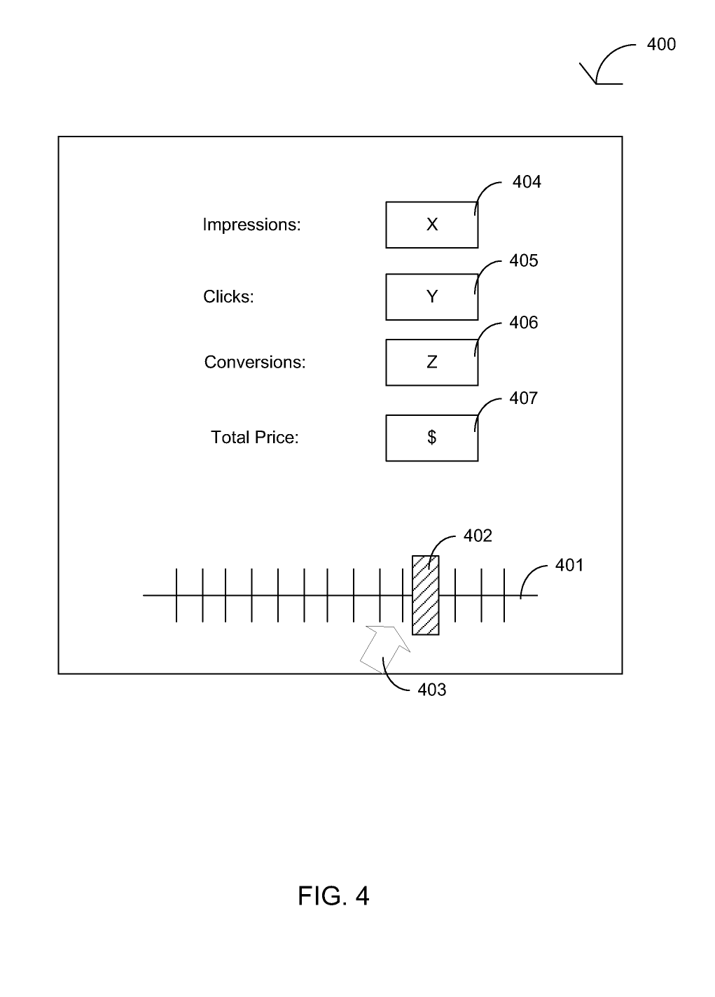

One feature provided in certain implementations is a reporting system that allows content providers to interact with a user interface display element, such as a sliding bar, to adjust the content provider's CPC or CPM. The content provider then can see the potential price paid information and impression, click and conversion volume for a future time window, and then advertisers can set their bid price based on this information. An exemplary implementation of such a system is now described with reference to FIG. 4. A display user interface 400 includes a sliding display element 402 that is slidable along an axis 401. A user of the user interface 400 can control arrow 403 via a user input device, e.g. a computer mouse or keyboard. By controlling arrow 403, the user can select sliding display element 402 and cause it to slide along axis 401. The position of sliding display element 402 along axis 401 is detected by the user interface and is used to provide a bid price for use with the model. In response to processing the model and the bid price, the estimated price and metric can be displayed on the display user interface 400. In the implementation shown in the FIG. 4, an estimated number of impressions for the content delivery campaign is shown in box 404, an estimated number of clicks for the content delivery campaign is shown in box 405, and an estimated number of conversions for the content delivery campaign is shown in box 406. A total price for the content delivery campaign is also shown in box 407. In other implementations, an estimated unit price, such as an estimated price per click, or a total estimated cost per conversion can be shown as well, or as an alternative. Based on the estimated number of conversions, the content provider can then estimate total revenues resulting from the content delivery campaign, as the content provider may have estimates for the average amount of revenue that is associated with a conversion. In implementations where the content provider also provides the estimated revenue per conversion, the display user interface 400 also may show other information such as total revenue expected from the content delivery campaign. In still further implementations, an optimization problem may be solved, such as to search for and report an optimum bid price to maximize total profit (revenue minus expenses) for a content delivery campaign.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied in a tangible medium, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus or processing circuit on data stored on one or more computer-readable storage devices or received from other sources.

The term “client or “server” includes all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, the method comprising:
receiving, by a computer system, a computer-implemented model adapted to process parameters of a content delivery campaign and a price to be bid for delivery of content in available content delivery slots as part of the content delivery campaign, wherein the price to be paid for delivery of content in the available content delivery slots is based on at least one losing bid, wherein the processing of the parameters and the price to be bid determines an estimated price to be paid for the delivery of content and a metric describing an estimated result of the content delivery campaign;
receiving, by the computer system, the parameters of the content delivery campaign and the price to be bid for delivery of content in available content delivery slots as part of the content delivery campaign;
processing, by the computer system, the model and the price to be bid, to determine the estimated price to be paid for the delivery of content and the metric describing the estimated result of the content delivery campaign; and
providing information about the estimated price and the estimated result to a content provider to facilitate selection of a final bid price for the content delivery campaign.

2. The method of claim 1, wherein the estimated result is a number of impressions that are expected to be achieved during the content delivery campaign.

3. The method of claim 1, wherein the estimated result is a number of clicks that impressions are expected to receive during the content delivery campaign.

4. The method of claim 1, wherein the estimated result is a number of conversions that are expected to be achieved during the content delivery campaign.

5. The method of claim 1, wherein the price to be bid is based on a cost per impression of content delivered as part of the content delivery campaign.

6. The method of claim 1, wherein the price to be bid is based on a cost per click received by the content delivered as part of the content delivery campaign.

7. The method of claim 1, wherein the computer-implemented model is generated using a learning algorithm.

8. The method of claim 7, wherein the learning algorithm includes a support vector machine.

9. The method of claim 7, wherein the learning algorithm includes a logistic regression.

10. The method of claim 1, further including:
providing, via a display, a user interface to the content provider, the user interface including a selection mechanism for selecting the price to be bid;
wherein providing information about the estimated price and the estimated result to the content provider includes displaying, via the display, at least one of an estimated number of impressions, an estimated number of clicks, and an estimated number of conversions of the content delivery campaign.

11. The method of claim 10, wherein the selection mechanism includes a sliding display element, wherein selecting the price to be bid includes setting a position of the sliding display element via the user interface.

12. A computer-readable storage medium encoded with instructions that, when executed on a processing unit, perform a method, the method comprising:
receiving, by a computer system, a computer-implemented model adapted to process parameters of a content delivery campaign and a price to be bid for delivery of content in available content delivery slots as part of the content delivery campaign, wherein the price to be paid for delivery of content in the available content delivery slots is based on at least one losing bid, wherein the processing of the parameters and the price to be bid determines an estimated price to be paid for the delivery of content and a metric describing an estimated result of the content delivery campaign;
receiving, by the computer system, the parameters of the content delivery campaign and the price to be bid for delivery of content in available content delivery slots as part of the content delivery campaign;
processing, by the computer system, the model and the price to be bid, to determine the estimated price to be paid for the delivery of content and the metric describing the estimated result of the content delivery campaign; and
providing information about the estimated price and the estimated result to a content provider to facilitate selection of a final bid price for the content delivery campaign.

13. The computer-readable storage medium of claim 12, wherein the estimated result is a number of impressions that are expected to be achieved during the content delivery campaign.

14. The computer-readable storage medium of claim 12, wherein the estimated result is a number of clicks that impressions are expected to receive during the content delivery campaign.

15. The computer-readable storage medium of claim 12, wherein the estimated result is a number of conversions that are expected to be achieved during the content delivery campaign.

16. The computer-readable storage medium of claim 12, wherein the price to be bid is based on a cost per impression of content delivered as part of the content delivery campaign.

17. The computer-readable storage medium of claim 12, wherein the price to be bid is based on a cost per click received by the content delivered as part of the content delivery campaign.

18. The computer-readable storage medium of claim 12, wherein the computer-implemented model is generated using a learning algorithm.

19. The computer-readable storage medium of claim 18, wherein the learning algorithm includes a support vector machine.

20. The computer-readable storage medium of claim 18, wherein the learning algorithm includes a logistic regression.
